(19) United States
(12) Patent Application Publication
(10) Pub. No.: US 2025/0033320 A1
(43) Pub. Date: Jan. 30, 2025

(54) ECO-FRIENDLY PANEL AND METHOD OF MANUFACTURING SAME

(71) Applicant: JUNYOUNG PARK, Seoul (KR)

(72) Inventor: JUNYOUNG PARK, Seoul (KR)

(21) Appl. No.: 18/696,259

(22) PCT Filed: Sep. 23, 2022
(86) PCT No.: PCT/KR2022/014282

§ 371 Date: Oct. 7, 2024

(30) Foreign Application Priority Data
Oct. 21, 2021 (KR) 10-2021-0140847

(51) Int. Cl. B32B 5/02; B32B 9/00; B32B 17/10; B32B 27/36; B32B 37/06; B32B 37/10

(52) U.S. Cl. CPC B32B 5/02; B32B 9/007; B32B 17/10981; B32B 27/36; B32B 37/06; B32B 37/10

(57) ABSTRACT

The present invention relates to an eco-friendly panel and a manufacturing method therefor. Specifically, the eco-friendly panel includes: a waste fiber felt layer molded from at least one selected from the group consisting of polyester, cotton, and other fibers that are classified as waste fibers and cut into predetermined sizes; at least one mucous layer in which at least one powder selected from the group consisting of zeolite powder, bentonite, montmorillonite, briquette ash, volcanic soil, perlite, ocher, charcoal, orthoclase powder, elvan powder, jade powder, germanium powder, and calcined shell powder is stirred in mixture with a mucilage substance extracted from waste algae such as waste brown algae, waste red algae, or waste green algae; and at least one nanocarbon layer in which plate-shaped graphite, graphene, and boron nitride are mixed at a weight ratio of 2:1:0.5, wherein copies of the waste fiber felt layer, the mucous layer, and the nanocarbon layers are sequentially or non-sequentially stacked and hardened through heat compression and cold compression.

### TECHNICAL FIELD

The present invention relates to an eco-friendly panel and a method of manufacturing the same. Specifically, the present invention relates to an eco-friendly building panel as a functional building panel using waste fibers and a method of manufacturing the same. The eco-friendly building panel is densely hardened using an eco-friendly adhesive without using a chemical polymer adhesive and thus has enhanced durability.

### BACKGROUND ART

A chronic problem in modern society is that nature is damaged due to all kinds of f industrial and household wastes and environmental destruction caused thereby.

Recently, in recognition of the need for environmental protection, solutions through the recycling and natural decomposition of various environmental wastes have been proposed, and some policies have been implemented. However, extension to various aspects of materials is quite insufficient.

In particular, while the amount of all sorts of textile waste generated from industrial or household waste overwhelmingly increases, suggestions on how to properly recycle the waste are insufficient.

Known specific methods of recycling textile waste include a method of using the waste as all kinds of fillers, a method of simply reusing the waste as non-woven fabrics, mats, rugs, quilts, or bags, or a method of recycling the waste as reinforced plastics, caprolactam, or solid recovered fuel (SRF).

In the case of domestic technologies for recycling into building materials in Korea, methods of manufacturing artificial wood using waste fibers and waste plastics, manufacturing interior materials for buildings using waste fibers and stone dust, or manufacturing interior materials for automobiles using waste fibers have been provided.

In addition, manufacturing technology of panels using waste fibers and waste paper as raw materials is also known.

In the case of overseas technologies, known technologies include remanufacturing waste fibers into cotton, manufacturing alternative paper using waste fibers, and manufacturing insulation boards using textile waste.

However, even with such technologies for recycling waste fibers into building materials, cotton fibers cannot be recycled, and the use of chemical polymer resin adhesives is necessary to impart strong adhesion and hardness.

When applying heat, cotton fibers are irreversibly damaged due to thermosetting properties. As a result, the cotton fibers are reusable but not recyclable. In addition, the use of chemical polymer resin adhesives may release substances harmful to the human body, which goes against the trend of eco-friendly and nature-friendly construction and may harm the human body.

Therefore, among technologies for developing building materials using waste fibers, eco-friendly adhesives capable of replacing the use of chemical polymer adhesives, which are harmful to the human body, are required to be developed, as well as the technologies enabling building materials using waste fibers to have uniform strength and hardness with the use of such developed adhesives.

### DISCLOSURE

### Technical Problem

An objective of the present invention is to provide an eco-friendly functional panel that is heat-insulating, soundproofing, heat-preserving, shock-absorbing, and durable as a building material with uniform strength by recycling waste fiber and a natural adhesive made of eco-friendly material.

Another objective of the present invention is to provide a method of manufacturing a panel in which a durable reinforced panel can be produced and manufactured on a large scale by using waste fiber and environmental or natural waste.

### Technical Solution

To achieve the above objectives, an eco-friendly panel, according to one embodiment of the present invention, is constructed in a form in which at least one panel being a laminate of a waste fiber felt layer, a viscous liquid layer made of a natural material, and a nano-carbon layer is compressed. A plurality of individual panels may be compressed, and both the surfaces may be covered with an exterior finishing material to make the eco-friendly panel available on the market.

Specifically, the main layer of the individual panel, according to the embodiment of the present invention, is the waste fiber felt layer formed by molding one or more types of fiber selected from the group consisting of a polyester-based fiber, a cotton fiber, and other fibers that are separated from a waste fiber and are cut into a predetermined size.

In addition, the viscous liquid layer laminated on the waste fiber felt layer is a component formed by stirring one or more types of powder selected from the group consisting of zeolite powder, bentonite, montmorillonite, briquette ash, volcanic soil, perlite, red clay, charcoal, orthoclase powder, elvan powder, jade powder, germanium powder, and baked shell powder, which increase the strength of the panel after hardening, with a viscous liquid material extracted from seaweed waste, such as brown, red, or green seaweed waste.

In addition, at least one of the nano-carbon layers in which flake graphite, graphene, and boron nitride are mixed in a weight ratio of 2:1:0.5 is further positioned on the waste fiber felt layer and the viscous liquid layer.

Respective layers of the waste fiber felt layer, the viscous liquid layer, and the nano-carbon layer may be sequentially or nonsequentially laminated to form one individual panel. In another embodiment, a plurality of waste fiber felt layers, a plurality of viscous liquid layers, and a plurality of nano-carbon layers may be laminated to form one individual panel.

A plurality of such formed individual panels may be laminated and hardened by performing thermal compression and cold compression to construct the eco-friendly panel according to the present invention.

In some cases, the eco-friendly panel, according to the present invention, may be completed by further covering both the surfaces of the panel with the exterior finishing material.

In one embodiment of the present invention, the thermal compression mentioned above is a method in a manner of compressing at least one of the individual panels composed of the laminate of the plurality of waste fiber felt layers, the plurality of viscous liquid layers, and the plurality of nano-carbon layers, using a thermal compression molding machine at a temperature in a range of 150° C. to 220° C. at a pressure in a range of 100 kg/cm2 to 150 kg/cm2.

In addition, the following cold compression is a process in a manner of compressing at least one of the thermally compressed individual panels, that is, at least one of the panels including the waste fiber felt layer, the viscous liquid layer, and the nano-carbon layer, using a cold press machine at a temperature in a range of 5° C. to 15° C. at a pressure in a range of 100 kg/cm2 to 200 kg/cm2, after the thermal compression.

The waste fiber felt layer, according to one embodiment of the present invention, may be a component formed by cutting the polyester-based fiber, the cotton fiber, and the other fibers, which are separated from the waste fiber, into a circular form having a diameter in a range of 3 cm to 5 cm or a square form having a horizontal length and a vertical length each in a range of 3 cm to 5 cm, using a scutcher to obtain an unraveled cotton-type fiber, and then cross-linking the unraveled cotton-type fiber to form a mesh-type structure using a needle punching machine. However, the shapes and sizes being cut are not limited.

In one embodiment of the present invention, the other fibers may include any one type of fiber selected from polyamide-based fibers, polyacrylonitrile-based fibers, polyurethane-based fibers, polyolefin-based fibers, and polyvinyl alcohol-based fibers. However, the other fibers are not necessarily limited thereto, and all kinds of synthetic fibers capable of being unraveled into the cotton-type fiber may be used.

In addition, at least one of the waste fiber felt layers, according to another embodiment of the present invention, preferably includes a first layer in which the polyester-based fiber separated from the waste fiber accounts for 100% by weight with respect to the total weight of a single layer, and a layer in which the polyester-based fiber, the cotton fiber, and the other fibers, separated from the waste fiber, account for 40% to 70% by weight, 20% to 40% by weight, and 10% to 20% by weight, respectively, with respect to the total weight of the single layer. According to one embodiment of the present invention, the brown seaweed waste may include sea mustard waste, kelp waste, hijiki waste, sea trumpet waste, and Sargassum horneri waste, the red seaweed waste may include layer waste, sea string waste, and Gelidium amansii waste, and the green seaweed waste may include sea lettuce waste and Ulva pertusa Kjellman waste. However, the brown, red, and green seaweed wastes are not limited thereto, and any seaweed present as natural waste may be used.

In addition, in one embodiment of the present invention, among the variety of types of powder, a mixed powder in which the red clay, the charcoal, and the orthoclase powder are mixed in a weight ratio in a range of 2 to 3:1:1 is preferably used for the viscous liquid layer. As the seaweed waste, the viscous liquid material extracted from the Sargassum horneri waste and the Ulva pertusa Kjellman waste is preferably used. More preferably, the viscous liquid material may be diluted to be 1 to 2 times as much the weight of the mixed powder and stirred for use.

According to one embodiment of the present invention, the viscous liquid material may be a component formed by the following processes: immersing the seaweed waste in lukewarm water 2 to 5 times as much the weight of the seaweed waste for 3 hours to 5 hours at least 2 to 5 times to obtain a desalted seaweed waste; grinding the desalted seaweed waste to obtain a first ground product having a size in a range of 1 cm to 5 cm; adding a deodorant liquid containing 100 parts by weight of water and 20 parts to 40 parts by weight of an activated carbon powder 2 to 4 times as much the weight of the first ground product to obtain a second ground product; heating the second ground product to a temperature in a range of 80° C. to 100° C. for 1 hour to 3 hours to obtain a gelatinized liquid; cooling the gelatinized liquid to room temperature and then filtering the resulting liquid; and controlling a viscosity using one or more types selected from glycerin, carrageenan, agar, and a modified starch.

A method of manufacturing an eco-friendly panel, according to another embodiment of the present invention, mainly includes the following processes: forming a waste fiber felt layer; forming a viscous liquid layer by stirring a powder with a viscous liquid material extracted from seaweed waste; forming a nano-carbon layer; and laminating the respective layers to form at least one individual panel and compressing the individual panel into a final panel.

Specifically, the process of forming the waste fiber felt layer includes the following steps: manufacturing a cotton-type fiber using a scutcher by collecting a waste fiber, separating the waste fiber into a polyester-based fiber, a cotton fiber, and other fibers, and cutting the separated fiber into a predetermined size; and forming a plurality of waste fiber felt layers by blending the cotton-type fiber to form a sheet-like felt using a molding machine and cross-linking the felt to form a mesh-type structure with a uniform density using a needle punching machine.

In addition, the process of forming the viscous liquid layer includes the following steps: desalting one or more types of seaweed wastes selected from brown, red, and green seaweed wastes with lukewarm water multiple times, grinding the desalted seaweed waste by adding 2 to 4 times as much water to obtain a mixture, and then mixing the mixture with an activated carbon powder in an amount of 20% to 40% by weight of the mixture to obtain a mixed solution; heating the mixed solution to a temperature in a range of 80° C. to 100° C. for 1 hour to 3 hours to obtain a gelatinized liquid, cooling the gelatinized liquid to room temperature, filtering the resulting liquid, and controlling a viscosity using one or more types selected from glycerin, carrageenan, agar, and a modified starch to prepare a viscous liquid; and mixing one or more types of powder selected from the group consisting of zeolite powder, bentonite, montmorillonite, briquette ash, volcanic soil, perlite, red clay, charcoal, orthoclase powder, elvan powder, jade powder, germanium powder, and baked shell powder with the viscous liquid in a weight ratio in a range of 1:1 to 2.

In addition, the nano-carbon layer is formed by using a nano-carbon material in which flake graphite, graphene, and boron nitride are mixed in a weight ratio of 2:1:0.5, and the viscous liquid layer (the layer in which the powder and the viscous liquid are mixed) and the nano-carbon layer are laminated (applied) on top of the plurality of waste fiber felt layers.

In the present invention, the viscous liquid layer and the nano-carbon layer laminated on top of the waste fiber felt layer in such a manner can be defined as an individual panel. At least one of the individual panels may undergo a first compression step performed using a thermal compression molding machine at a temperature in a range of 150° C. to 220° C. at a pressure in a range of 100 kg/cm2 to 150 kg/cm2 and a second compression step performed using a cold press machine at a temperature in a range of 5° C. to 15° C. at a pressure in a range of 100 kg/cm2 to 200 kg/cm2, after the first compression, to finally form the eco-friendly panel.

In another embodiment, a non-slip agent may be further applied on the contact surface of each of the plurality of waste fiber felt layers on which the viscous liquid layer, made of the powder and the viscous liquid, and the nano-carbon material (nano-carbon layer) are laminated, before the first compression step.

Preferably, the non-slip agent is a mixture in which one or more types of powder selected from the group consisting of a non-metal powder, a ceramic powder, aluminum oxide powder, and iron oxide powder are mixed, and the selected powder may have a particle size of 200 mesh or less.

More preferably, 2 parts to 5 parts by weight of the non-slip agent may be applied with respect to 100 parts by weight of the waste fiber felt layer.

### Advantageous Effects

According to the present invention, a panel that is harmless to the human body and eco-friendly as a functional reinforced building material can be provided by recycling waste fiber and a natural adhesive made of an eco-friendly material instead of using a chemical polymer adhesive harmful to the human body.

In particular, according to the present invention, a manufacturing method capable of mass-producing a functional panel that has enhanced durability and is heat-insulating, soundproofing, heat-preserving, and shock-absorbing can be provided by processing not only waste fiber but also environmental or natural waste to prepare a natural adhesive material and using such a prepared material. Therefore, the panel can be applied to various fields as architectural interior materials, such as sidewalk blocks, decks, benches, furniture, and interior and exterior finishing materials, in addition to basic building materials.

### DESCRIPTION OF DRAWINGS

FIG. 1 is a cross-sectional diagram illustrating an eco-friendly panel according to one embodiment of the present invention; and

FIG. 2 is a flowchart illustrating a method of manufacturing an eco-friendly panel according to one embodiment of the present invention.

### MODE FOR INVENTION

Hereinafter, embodiments of the present invention will be described in detail so that those skilled in the art can easily practice the present invention with reference to the accompanying drawings. However, the present invention can be variously modified and embodied in many different forms, and is not limited to the embodiments described herein. That is, the present invention should not be construed as being limited to only the embodiments set forth herein, but should be construed as covering modifications, equivalents, or alternatives falling within ideas and technical scopes of the present invention.

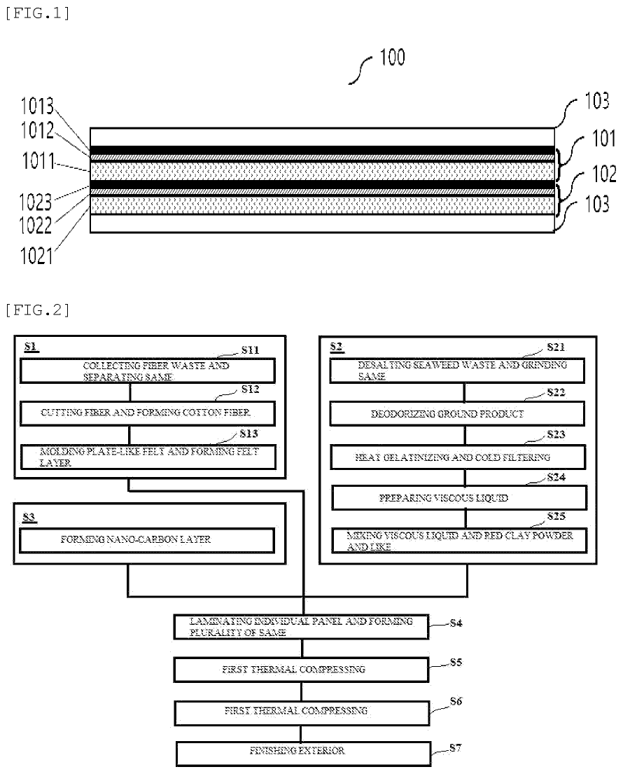

Hereinafter, descriptions will be made using a cross-sectional diagram according to the embodiment illustrated in FIG. 1 so that the construction of an eco-friendly panel, according to one embodiment of the present invention, can be understood in detail.

Referring to FIG. 1, an eco-friendly panel 100, according to one embodiment of the present invention, may be formed of one panel or formed by bonding two or more panels.

FIG. 1 discloses the panel composed of two panels, a first panel 101 and a second panel 102.

In the respective panels, waste fiber felt layers 1011 and 1021, viscous liquid layers 1012 and 1022 made of a natural material, and nano-carbon layers 1013 and 1023 are sequentially laminated. However, the lamination order of the respective layers is not necessarily limited.

Each of the respective layers serves a different function, and the eco-friendly panel may be constructed in a form in which at least one panel being a laminate of the respective layers is compressed. That is, depending on embodiments, respective layers of the waste fiber felt layer, the viscous liquid layer, and the nano-carbon layer may be sequentially or nonsequentially laminated to form one individual panel, as shown in FIG. 1. In another embodiment, a plurality of waste fiber felt layers, a plurality of viscous liquid layers, and a plurality of nano-carbon layers may be laminated to form one individual panel.

Lastly, a plurality of individual panels may be compressed, and both surfaces may be covered with an exterior finishing material 103 to make the eco-friendly panel available on the market.

The main layer of the individual panels 101 and 102, according to one embodiment of the present invention, is the waste fiber felt layer that is formed by molding any one or more types of fiber selected from the group consisting of a polyester-based fiber, a cotton fiber, and other fibers that are separated from a waste fiber and are cut into a predetermined size.

In particular, the polyester-based fiber, the cotton fiber, and other fibers, separated from the waste fiber, may be cut into a predetermined size and unraveled using a scutcher to obtain a cotton-type fiber, followed by cross-linking the unraveled cotton-type fiber to form a mesh-type structure using a needle punching machine.

The polyester-based fiber, the cotton fiber, and the other fibers may be cut into a circular form having a diameter in a range of 3 cm to 5 cm or a square form having a horizontal length and a vertical length each in a range of 3 cm to 5 cm.

The other fibers, other than the polyester-based or cotton fiber, may include any one type of fiber selected from polyamide-based fibers, polyacrylonitrile-based fibers, polyurethane-based fibers, polyolefin-based fibers, and polyvinyl alcohol-based fibers. However, the other fibers are not necessarily limited thereto, and all kinds of synthetic fibers capable of being unraveled into the cotton-type fiber may be used.

Preferably, the other fibers include one or more types of fiber selected from nylon, polyamide-based fibers containing aramid, polyacrylonitrile-based fibers, polyurethane-based fibers, polyolefin-based fibers, and polyvinyl alcohol-based fibers.

In addition, as at least one of the waste fiber felt layers according to another embodiment of the present invention, a first layer in which the polyester-based fiber separated from the waste fiber accounts for 100% by weight with respect to the total weight of a single layer, and a layer in which the polyester-based fiber, the cotton fiber, and the other fibers, separated from the waste fiber, account for 40% to 70% by weight, 20% to 40% by weight, and 10% to 20% by weight, respectively, with respect to the total weight of the single layer, are preferably blended for use. When the waste fiber felt layer is formed by blending a plurality of felt layers while including each type of constituent fiber in different weight ratios, durability and tensile strength can be significantly enhanced.

Here, when the content of the polyester-based fiber is less than 40% by weight with respect to the total weight of the single felt layer, this may lead to failure in thermal bonding. When the content of the polyester-based fiber exceeds 70% by weight, the content of the cotton fiber is reduced, thereby deteriorating soundproofing, heat preservation, and heat insulation functions. Therefore, the content ratio is controlled such that the polyester-based fiber accounts for 40% to 70% by weight with respect to the total weight of the single felt layer.

In addition, when the content of the cotton fiber is less than 20% by weight with respect to the total weight of the single felt layer, soundproofing, heat preservation, and heat insulation functions may be difficult to demonstrate sufficiently. When the content of the cotton fiber exceeds 40% by weight, the content of the polyester fiber is reduced, leading to failure in thermal bonding. Therefore, the content ratio of the cotton fiber is maintained to account for 20% to 40% by weight with respect to the total weight of the single felt layer so that heat insulation, soundproofing, heat preservation, and shock absorption functions are demonstrated.

In addition, the panels 101 and 102 include the viscous liquid layers 1012 and 1022, respectively, which are laminated on the respective waste fiber felt layer.

The viscous liquid layers 1012 and 1022 are components formed by stirring one or more types of powder selected from the group consisting of zeolite powder, bentonite, montmorillonite, briquette ash, volcanic soil, perlite, red clay, charcoal, orthoclase powder, elvan powder, jade powder, germanium powder, and baked shell powder, which can increase the strength of the panel after hardening, with a viscous liquid material extracted from seaweed waste, such as brown, red, or green seaweed waste.

Zeolite powder, bentonite, montmorillonite, briquette ash, volcanic soil, perlite, red clay, charcoal, orthoclase powder, elvan powder, jade powder, germanium powder, baked shell powder, and the like are mineral powders, which are used to enhance the mutual bonding strength of porous crystals between molecular substances.

Zeolite powder, bentonite, and montmorillonite are synthetic mineral materials, and briquette ash, volcanic soil, perlite, red clay, charcoal powder, orthoclase powder, elvan powder, jade powder, germanium powder, and baked shell powder are semi-incombustible substances having functional effects of releasing anions and emitting far-infrared rays. Thus, such powder can act as compound compositions capable of being used for building fiberboard that creates a comfortable living environment by emitting far-infrared rays and releasing anions.

Depending on embodiments, the mineral powder may be composed of components in various combinations and mixing ratios but is preferably composed of a mixed composition of germanium or jade powder and red clay powder with porous orthoclase powder.

when using the mixed composition of germanium or jade powder and red clay powder with the porous orthoclase powder as the mineral powder, the porous orthoclase powder, germanium or jade powder, and red clay powder are mixed in a weight ratio in a range of 2 to 3:1:1.

Here, the porous orthoclase powder is a component that demonstrates a heat insulation effect in the eco-friendly panel of the present invention. Typically, feldspar is the most common natural material among minerals constituting the Earth's crust, and is used as an industrial mineral in the manufacture of glass, paint, and the like. Mineral structures of such orthoclase are primarily related to Al/Si ordering-disordering, crystal twinning, intergrowth, and complex structures thereof (Parsons, 1994; Smith & Brown, 1988; Deer et al., 2001), and are secondarily classified into microstructures due to weather and erosion.

In particular, in a weathering process, fine pores are characteristically developed on the surface of orthoclase. Due to the porous structures of orthoclase, specific surface areas increase, volume decrease, characteristics and surface characteristics increase. As a result, electrical/magnetic and optical properties are known to be expressed (Park & Lee, 2000).

Therefore, in the present invention, the eco-friendly panel capable of demonstrating the heat insulation effect can be implemented with the use of the self-contained fine pores in the porous orthoclase powder.

The porous orthoclase powder with a particle size in a range of 40 μm to 1 mm is preferably used in terms of the heat insulation effect.

In addition, when separating the porous orthoclase powder into a powder with a particle size in a range of 40 μm to 500 μm and a powder with a particle size in a range of 500 μm to 1,000 μm so that the separated powders can be mixed with each other to form a composition, the overall density of a product can be increased while maintaining the inherent porosity in orthoclase, which is preferable.

In the meantime, the germanium or jade powder is magnetizable and can thus emit far-infrared rays or release anions autonomously.

As a result, the germanium or jade powder is widely used as an eco-friendly building material.

Such germanium or jade powder has a far-infrared emissivity (94%) that is about three times higher than those in the case of red clay and elvan. In addition, germanium is sometimes referred to as a stone of life and has the efficacy of eliminating carcinogens. Therefore, in the present invention, the germanium or jade powder may be mixed with the red clay powder in a weight ratio of 1:1 to improve the far-infrared emissivity and then mixed with porous orthoclase powder for use.

In the meantime, red clay powder has the mineralogical properties of clay minerals, such as dewaterability, suspensibility, ion exchangeability, plasticity, adsorption, and absorption properties. In addition, red clay powder is a natural material with higher activity than other minerals as well as a variety of properties, such as catalytic properties, large surface area, and absorption and emission of electromagnetic waves. When using such red clay, soil humidity can be well controlled, and because calcium carbonate is contained in red clay, the function of neutralizing acid rain is obtained, thereby obtaining the effect of preventing soil acidification.

In addition, red clay itself can control humidity well and emit far-infrared rays, and thus is a significantly beneficial material for the human body. Furthermore, red clay is known as a significantly eco-friendly component because the efficacies thereof in the treatment and improvement of water and soil are obtained by the activities of a variety of minerals and enzymes.

The red clay powder may be mixed with the germanium or jade powder in a weight ratio of 1:1 and then mixed with the porous orthoclase powder for use.

Materials constituting the viscous liquid layers 1012 and 1022 include the viscous liquid material extracted from the seaweed waste, such as the brown, red, or green seaweed waste, in addition to the mineral powder, such as zeolite powder, bentonite, montmorillonite, briquette ash, volcanic soil, perlite, red clay, charcoal, orthoclase powder, elvan powder, jade powder, germanium powder, and baked shell powder.

The brown seaweed waste may include sea mustard waste, kelp waste, hijiki waste, sea trumpet waste, and Sargassum horneri waste. The red seaweed waste may include layer waste, sea string waste, and Gelidium amansii waste. The green seaweed waste may include sea lettuce waste and Ulva pertusa Kjellman waste. However, the brown, red, and green seaweed wastes are not limited thereto.

Materials constituting the viscous liquid layers 1012 and 1022 are not particularly limited. However, in a preferred embodiment, the mineral powder in which the red clay, charcoal, and orthoclase powder are mixed in a weight ratio in a range of 2 to 3:1:1 may be stirred with the viscous liquid material extracted from Sargassum horneri waste and Ulva pertusa Kjellman waste in a weight ratio in a range of 1:1 to 2 for use.

In particular, the viscous liquid material is a component extracted from the seaweed waste for use, and is thus excellently used in terms of utilization of seaweed waste, which is waste in a marine environment. In particular, when using sea lettuce waste and Ulva pertusa Kjellman waste, which have been recent problems as malodorous natural waste on the coast of Jeju Island, two effects can be obtained: protection and utilization of the natural environment.

The annual amount of Ulva pertusa Kjellman being collected is estimated to be in a range of 25 million tons to 30 million tons, and the collection, separation, and processing thereof cost more than 1 billion won. However, the technology to which Ulva pertusa Kjellman is applied is limited to bioethanol production. Thus, Ulva pertusa Kjellman can be used in a desirable manner to be used as an eco-friendly building material, like the present invention, by processing fresh materials, before generating odors caused by decomposition.

In the meantime, in another embodiment of the present invention, among the variety of types of powder, the mixed powder in which the red clay, charcoal, and orthoclase powder are mixed in a weight ratio in a range of 2 to 3:1:1 is preferably used for the viscous liquid layer. In addition, the viscous liquid material extracted from the seaweed waste, the Sargassum horneri waste and the Ulva pertusa Kjellman waste, may be used. More preferably, the viscous liquid material may be diluted to be 1 to 2 times as much the weight of the mixed powder and stirred for use.

According to a further embodiment of the present invention, the viscous liquid material may be a component formed by the following processes: immersing the seaweed waste in lukewarm water 2 to 5 times as much the weight of the seaweed waste for 3 hours to 5 hours at least 2 to 5 times to obtain a desalted seaweed waste; grinding the desalted seaweed waste to obtain a first ground product having a size in a range of 1 cm to 5 cm; adding a deodorant liquid containing 100 parts by weight of water and 20 parts to 40 parts by weight of an activated carbon powder 2 to 4 times as much the weight of the first ground product to obtain a second ground product; heating the second ground product to a temperature in a range of 80° C. to 100° C. for 1 hour to 3 hours to obtain a gelatinized liquid; cooling the gelatinized liquid to room temperature and then filtering the resulting liquid; and controlling a viscosity using one or more types selected from glycerin, carrageenan, agar, and a modified starch.

In addition, according to the embodiment illustrated in FIG. 1, at least one of the respective nano-carbon layers 1013 and 1023 in which flake graphite, graphene, and boron nitride are mixed in a weight ratio of 2:1:0.5 may be further positioned on the respective waste fiber felt layers 1011 and 1021 and the respective viscous liquid layers 1012 and 1022.

The mixed material constituting the nano-carbon layers 1013 and 1023 is one in which flake graphite, graphene, and boron nitride are mixed in a weight ratio of 2:1:0.5.

Flake graphite has a maximized horizontal area and thus can excellently exhibit moisture-barrier properties while performing the function of preventing moisture migration. In addition, when combined with a polymer fiber material of the waste fiber felt layer or with a natural polymer material of the viscous liquid layer, tensile strength is increased. As a result, when applied to the eco-friendly panel, which is a building material, flake graphite has excellent functions of enhancing waterproofness and processability.

The thickness of the nano-carbon layers 1013 and 1023 is not particularly limited. However, the thickness may be formed to be several tens of micrometers or several millimeters so that strength and uniform properties caused by entanglement between the constituent material layers being laminated above and below can be maintained.

In a preferred embodiment, surface treatment may be performed on the nano-carbon layer composed of flake graphite, graphene, and boron nitride to increase interlayer bonding strength or improve dispersibility thereof.

In addition, in the surface treatment of the nano-carbon layers 1013 and 1023, a carboxy group (—COOH), hydroxyl group (—OH), or epoxy group may be introduced into the surface of the nano-carbon layer by being treated with an oxidizing agent or an acid.

As the acid for the surface treatment, an aqueous solution of inorganic acid selected from sulfuric acid, hydrochloric acid, and nitric acid may be typically used. In addition, hydrogen peroxide or the like may be used as the oxidizing agent.

Furthermore, while ultrasonic waves may be used to improve the dispersibility of the nano-carbon layers 1013 and 1023, the surface treatment using the acid or oxidizing agent and ultrasonic treatment may be used in combination.

In the present invention, the nano-carbon layers 1013 and 1023 form a composite with the material layers being in contact, thereby increasing tensile strength and enhancing moisture-barrier properties. In addition, due to long-term heat resistance, the nano-carbon layer may be enabled to maintain high stability of repaired concrete structures, after being constructed as the eco-friendly panel according to the present invention.

In addition, in the nano-carbon layers 1013 and 1023, boron nitride (BN), which is layered graphite, may be mixed and used to improve the ability of the moisture barrier and enhance strength.

As illustrated in FIG. 1, when laminating a plurality of panels, each of which is formed by sequentially laminating the waste fiber felt layer, the viscous liquid layer, and the nano-carbon layer, and hardening the plurality of panels by repeatedly performing thermal compression and cold compression, the eco-friendly panel 100, according to the present invention, is finally formed.

In one embodiment of the present invention, the thermal compression mentioned above is a method in a manner of compressing at least one of the individual panels composed of the laminate of the plurality of waste fiber felt layers, the plurality of viscous liquid layers, and the plurality of nano-carbon layers, using a thermal compression molding machine at a temperature in a range of 150° C. to 220° C. at a pressure in a range of 100 kg/cm2 to 150 kg/cm2.

In addition, the following cold compression is a process in a manner of compressing at least one of the thermally compressed individual panels, that is, at least one of the panels including the waste fiber felt layer, the viscous liquid layer, and the nano-carbon layer, using a cold press machine at a temperature in a range of 5° C. to 15° C. at a pressure in a range of 100 kg/cm2 to 200 kg/cm2, after the thermal compression.

In the meantime, a method of manufacturing an eco-friendly panel, according to another embodiment of the present invention, mainly includes the following processes: forming a waste fiber felt layer; forming a viscous liquid layer by stirring a powder with a viscous liquid material extracted from seaweed waste;

forming a nano-carbon layer; and laminating the respective layers to form at least one individual panel and compressing the individual panel into a final panel.

Hereinafter, descriptions will be made using a flowchart according to the embodiment illustrated in FIG. 2 so that the method of manufacturing the eco-friendly panel, according to one embodiment of the present invention, can be understood in detail.

Referring to FIG. 2, the method of manufacturing the eco-friendly panel includes the following processes as a preparatory process: S1 of forming a waste fiber felt layer, S2 of forming a viscous liquid layer by stirring a powder with a viscous liquid material extracted from seaweed waste, and S3 of forming a nano-carbon layer.

Thereafter, the constituent material layers formed in Steps S1, S2, and S3 are sequentially laminated to finally produce the eco-friendly panel.

Specifically, S1, the process of forming the waste fiber felt layer, includes the following steps: S11 of collecting a waste fiber and separating the collected waste fiber into a polyester-based fiber, a cotton fiber, and other fibers, S12 of cutting the separated fiber into a predetermined size to obtain a cotton-type fiber using a scutcher, and S13 of blending the cotton-type fiber to form a sheet-like felt using a molding machine and cross-linking the felt to form a mesh-type structure with a uniform density using a needle punching machine, thereby forming a plurality of waste fiber felt layers.

More specifically, in Step S11, the waste fiber is collected and separated into the cotton fiber, the polyester-based fiber, and the other fibers. The polyester fiber may be produced from waste plastics, such as PET bottles, through recycling processes.

Next, in Step S12, the separated waste fiber is cut into a predetermined size and then undergoes a scutching process. That is, in S12, the cotton fiber, the polyester fiber, and the other fibers, separated from the waste fiber, are cut into the predetermined size using a known rotary cutter, and then undergo the scutching process.

The cut size is not particularly limited but preferably in a range of 3 cm to 5 cm×3 cm to 5 cm. The scutching process is a step of unraveling the fiber being cut into the cotton-type fiber using the scutcher (cotton gin).

In Step S13, a blending process is performed, in which threads being scutched and separated are put into a well-known mixing tank for blending.

For example, when the plurality of felt layers is formed and blended, 100% by weight of the polyester-based fiber is preferably used in the forming of the outermost felt layers.

In addition, when forming inner felt layers positioned between the outermost felt layers, the polyester-based fiber, the cotton fiber, and the other fibers preferably account for 40% to 70% by weight, 20% to 40% by weight, and 10% to 20% by weight, respectively. Each of the above weight percentages is based on the total weight of the single felt layer.

Each of the content ranges of the blended fibers included in the outermost and inner felt layers is specified as described above. This is because when the content of the polyester-based fiber is less than 40% by weight, this may lead to failure in thermal bonding, and when the content of the polyester-based fiber exceeds 70% by weight, the content of the cotton fiber is reduced, thereby deteriorating soundproofing, heat preservation, and heat insulation functions. In addition, when the content of the cotton fiber is less than 20% by weight, soundproofing, heat preservation, and heat insulation functions are difficult to demonstrate sufficiently. When the content of the cotton fiber exceeds 40% by weight, the content of the polyester fiber is reduced, leading to failure in thermal bonding.

When forming at least one of the inner felt layers as described in the above embodiment, heat insulation, soundproofing, heat preservation, and shock absorption functions can be demonstrated with 20% to 40% by weight of the cotton fiber.

In addition, the fibers blended in Step S13 are processed using a carding machine and a scrubbing machine, which are well-known, to be arranged with predetermined size and thickness, and then processed using a pressure roller in a molding machine to form a sheet-like felt that is softly and horizontally molded.

The pressure roller of the well-known molding machine may be operated in an atmosphere at a pressure of 100 kg/cm2 at a temperature in a range of 50° C. to 70° C.

The sheet-like felts are cross-linked to form a mesh-type structure with a uniform density using a needle punching machine, thereby forming the plurality of waste fiber felt layers.

That is, using the needle punching machine, the sheet-like felt is cross-linked such that the unraveled fiber crisscrossed in the form of a vertically long needle loop, when viewed in the cross-sectional diagram, can be formed into the mesh-type structure with a high density of 1.18 g/cm2 or more. In other words, a portion of two-dimensional fiber being randomly arranged is combined in a three-dimensional structure by repeatedly moving a designated needle plate to which a long needle is attached, up and down. After the cross-linking, the volume is reduced to 70% compared to that of the sheet-like felt being molded.

In one embodiment of the present invention, the viscous liquid layer is formed as another preparatory process in S2, which specifically includes the following steps: S21 of desalting seaweed waste and grinding the desalted seaweed waste, S22 of deodorizing an off smell, such as a peculiar fishy smell and the like, from the ground product, S23 of heating the deodorized product, gelatinizing the heated product, and then cold-filtering the gelatinized product, S24 of preparing a viscous liquid therethrough, and S25 of mixing a red clay powder and the like with the viscous liquid.

First, in Step S21, the seaweed waste undergoing the desalting and grinding processes includes at least one type of seaweed wastes selected from brown, red, and green seaweed wastes.

The seaweed waste randomly selected or collected for environmental waste disposal is desalted multiple times with lukewarm water and ground by adding 2 to 4 times as much water.

The temperature of the lukewarm water is in a range of 40° C. to 50° C. The desalting process is performed multiple times while changing the water every 3 hours to 4 hours in an amount of 2 to 4 times.

The desalted seaweed waste is firstly ground roughly using a mill, and, secondarily, coarsely ground after adding 1 to 4 times as much water to prepare a fine paste. The purpose of the coarse grinding is to enhance the deodorizing effect capable of eliminating off-smells of the seaweed and to easily convert insoluble alginic acid to water-soluble alginic acid by heating.

In the deodorizing process of S22, the seaweed coarsely ground in Step S21 and water are put in a heating container in a ratio in a range of 1:1 to 2 with 20% to 30% by weight of an activated carbon deodorant with respect to the weight of the seaweed. Then, the resulting mixture is boiled to a temperature in a range of 80° C. to 100° C. for 0.5 hours to 1 hour and undergoes deodorization and pyrolysis to obtain a gelatinized seaweed paste.

Then, in S23, the gelatinized seaweed paste is rapidly cooled with cold water at a temperature in a range of 0° C. to 25° C. to prevent polymerization reactions of the fiber components constituting the seaweed from occurring, and the cooled seaweed paste is then filtered to remove activated carbon particles. Next, in S24, 10% to 20% by weight of glycerin, 5% to 15% by weight of an alkyl diaminoethyl glycine hydrochloride solution (at a concentration of 30%), and 2% to 5% by weight of an aloe extract are added thereto, with respect to the total weight of the seaweed film components, and then the resulting product is coarsely ground once more, leading to an increase in the volume due to the generation of bubbles. As a result, a paste with high viscosity, that is, the viscous liquid, is formed.

Regarding the above composition ratio of the components, when the content of glycerin is less than 10% by weight, film flexibility deteriorates. When the content of glycerin exceeds 20% by weight, the strength of the film is weakened, and the risk of breakage is thus increased. In addition, when the content of alkyl diaminoethyl glycine hydrochloride is less than 5% by weight, the elasticity and antibacterial activity of the film are reduced. When the content of alkyl diaminoethyl glycine hydrochloride exceeds 15% by weight, there is a concern that through holes may be formed in the film.

In another embodiment according to the present invention, when 9% to 18% by weight of ethyl alcohol is further added thereto, mixed, and then ground, small particles may be decomposed. As a result, viscous liquid film raw material of translucent water-soluble seaweed may be produced.

In addition, the film raw material may be applied on release sheet paper to a thickness in a range of 0.5 mm to 2 mm, hot-air dried in a drying room at a temperature in a range of 50° C. to 60° C. for 3 hours to 4 hours, and then separated from the release paper to form a seaweed film.

In S23, the mixed solution is heated to a temperature in a range of 80° C. to 100° C. for 1 hour to 3 hours and gelatinized. Then, the gelatinized liquid is cooled to room temperature for filtering, and the viscosity of the resulting liquid is controlled with one or more types selected from glycerin, carrageenan, agar, and a modified starch in S24 to prepare a viscous liquid. Then, Step S25 of mixing one or more types of powder selected from the group consisting of zeolite powder, bentonite, montmorillonite, orthoclase powder, elvan powder, jade powder, germanium powder, and baked shell powder and the viscous liquid prepared in S24 above in a weight ratio in a range of 1:1 to 2 is included.

Specifically, in Step S25, one or more types of mineral material selected from synthetic mineral materials, such as nano-ceramic powder, elvan powder, zeolite powder, bentonite, antibacterial ceramic powder, and montmorillonite, and the viscous liquid prepared in S24 are mixed to enhance the mutual bonding properties of porous crystals between molecular substances.

In particular, among the mineral materials, charcoal powder has a porous form like numerous honeycombs, thereby adsorbing odors, humidity, and harmful 1 substances while having heat preservation properties to maintain an appropriate temperature. In addition, charcoal powder adsorbs moisture and releases moisture in a dry environment to enable humidity control. Furthermore, charcoal powder exhibits a strong reducing activity and an energy-boosting activity, and thus has an air purification function of removing formaldehyde, odors, and smells.

The manufacturing method, according to one embodiment of the present invention, includes S1 and S2, the processes in which the felt layer and the viscous liquid layer of the eco-friendly panel are formed, respectively, as well as S3, the process in which the nano-carbon layer is formed, at the same time or before or after S1 and S2.

Specifically, in S3, a nano-carbon material in which flake graphite, graphene, and boron nitride are mixed in a weight ratio of 2:1:0.5 is formed.

Here, the viscous liquid layer (the layer in which the mineral powder and the viscous liquid are mixed) and the nano-carbon layer are laminated (applied) on top of the plurality of waste fiber felt layers.

In the present invention, the viscous liquid layer and the nano-carbon layer laminated on top of the waste fiber felt layer can be defined as one individual panel.

In the following process of S4, a plurality of individual panels is formed by laminating the respective layers formed in Steps S1, S2, and S3, the preparatory processes.

Next, in S5, a first compression is performed on at least one of the individual panels using a thermal compression molding machine at a temperature in a range of 150° C. to 220° C. at a pressure in a range of 100 kg/cm2 to 150 kg/cm2.

In Step S6, a second compression is performed at a temperature in a range of 5° C. to 15° C. at a pressure in a range of 100 kg/cm2 to 200 kg/cm2 using a cold press machine, after the first compression. Thereafter, in S7, both the outermost surfaces are covered with an exterior material so that the eco-friendly panel can be finally formed.

In the meantime, in another embodiment, a non-slip agent may be further applied on the contact surface of each of the plurality of waste fiber felt layers on which the viscous liquid layer, made of the powder and the viscous liquid, and the nano-carbon material (nano-carbon layer) are laminated, before the first compression of Step S5.

Preferably, the non-slip agent is a mixture in which one or more types of powder selected from the group consisting of a non-metal powder, a ceramic powder, aluminum oxide powder, and iron oxide powder are mixed, and the selected powder may have a particle size of 200 mesh or less.

More preferably, 2 parts to 5 parts by weight of the non-slip agent may be applied with respect to 100 parts by weight of the waste fiber felt layer.

The eco-friendly panel of the present invention, manufactured according to the embodiment illustrated in FIG. 2, has a uniform density and high strength. As a result, the panel can be used as basic building materials, such as medium-density fiberboard (MDF), plywood, partition board, and gypsum board, as well as other applied products, such as sidewalk blocks, decks, benches, furniture, and interior/exterior finishing materials.

The above description of the present invention is given by way of illustration only, and those who are skilled in the art will appreciate that various alternatives, modifications, and equivalents are possible, without changing the spirit or essential features of the present invention. Therefore, embodiments of the present invention have been described for illustrative purposes, and should not be construed as being restrictive. For example, each component described as a singular form may be implemented in a distributed form, and similarly, components described as distributed may also be implemented in a combined form. The terms used herein are for the purpose of describing particular embodiments only and are not intended to be limiting. It will be further understood that the terms “comprises,” “comprising”, “includes”, and/or “including” when used herein, specify the presence of stated features, integers, steps, operations, elements, components, or combinations thereof, but do not preclude the presence or addition of one or more other features, integers, steps, operations, elements, components, or combinations thereof. The scope of the present invention is defined by the accompanying claims rather than the description which is presented above. Moreover, the scope of the present invention should be construed as covering all alternatives and modifications obtained from the meaning, scope, and equivalents of the appended claims.

### EXPLANATION OF REFERENCE NUMERALS

100: Eco-friendly panel
101: First panel
102: Second panel
1011, 1021: Waste fiber felt layer
1012, 1022: Viscous liquid layer
1013, 1023: Nano-carbon layer
103: Exterior finishing layer

1. An eco-friendly panel comprising:
at least one waste fiber felt layer formed by molding one or more types of fiber selected from the group consisting of a polyester-based fiber, a cotton fiber, and other fibers that are separated from a waste fiber and are cut into a predetermined size;
at least one viscous liquid layer formed by stirring one or more types of powder selected from the group consisting of zeolite powder, bentonite, montmorillonite, briquette ash, volcanic soil, perlite, red clay, charcoal, orthoclase powder, elvan powder, jade powder, germanium powder, and baked shell powder with a viscous liquid material extracted from a seaweed waste comprising a brown, red, or green seaweed waste; and
at least one nano-carbon layer in which flake graphite, graphene, and boron nitride are mixed,
wherein the waste fiber felt layer, the viscous liquid layer, and the nano-carbon layer are sequentially or nonsequentially laminated and hardened by thermal compression and cold compression.

2. The panel of claim 1, wherein the thermal compression is performed on the resulting laminate of a plurality of waste fiber felt layers, a plurality of viscous liquid layers, and a plurality of nano-carbon layers, using a thermal compression molding machine at a temperature in a range of 150° C. to 220° C. at a pressure in a range of 100 kg/cm2 to 150 kg/cm2, and
the cold compression is performed on the thermally compressed laminate of the plurality of waste fiber felt layers, the plurality of viscous liquid layers, and the plurality of nano-carbon layers, using a cold press machine at a temperature in a range of 5° C. to 15° C. at a pressure in a range of 100 kg/cm2 to 200 kg/cm2.

3. The panel of claim 1, wherein the waste fiber felt layer is a component formed by cutting the polyester-based fiber, the cotton fiber, and the other fibers, which are separated from the waste fiber, into a circular form having a diameter in a range of 3 cm to 5 cm or a square form having a horizontal length and a vertical length each in a range of 3 cm to 5 cm, using a scutcher to obtain an unraveled cotton-type fiber, and then cross-linking the unraveled cotton-type fiber to form a mesh-type structure using a needle punching machine.

4. The panel of claim 1, wherein the other fibers comprise any one type of fiber selected from a polyamide-based fiber, a polyacrylonitrile-based fiber, a polyurethane-based fiber, a polyolefin-based fiber, and a polyvinyl alcohol-based fiber.

5. The panel of claim 1, wherein at least one of the waste fiber felt layers comprises a first layer in which the polyester-based fiber separated from the waste fiber accounts for 100% by weight with respect to the total weight of a single layer, and a layer in which the polyester-based fiber, the cotton fiber, and the other fibers, separated from the waste fiber, account for 40% to 70% by weight, 20% to 40% by weight, and 10% to 20% by weight, respectively, with respect to the total weight of the single layer.

6. The panel of claim 1, wherein the brown seaweed waste comprises sea mustard waste, kelp waste, hijiki waste, sea trumpet waste, and Sargassum horneri waste,
the red seaweed waste comprises layer waste, sea string waste, and Gelidium amansii waste, and
the green seaweed waste comprises sea lettuce waste and Ulva pertusa Kjellman waste.

7. The panel of claim 1, wherein the viscous liquid layer is a component formed by stirring a mixed powder in which the red clay, the charcoal, and the orthoclase powder are mixed in a weight ratio in a range of 2 to 3:1:1 with the viscous liquid material extracted from Sargassum horneri waste and Ulva pertusa Kjellman waste 1 to 2 times as much the weight of the mixed powder.

8. The panel of claim 1, wherein the viscous liquid material is a component formed by immersing the seaweed waste in lukewarm water 2 to 5 times as much the weight of the seaweed waste for 3 hours to 5 hours at least 2 to 5 times to obtain a desalted seaweed waste,
grinding the desalted seaweed waste to obtain a first ground product having a size in a range of 1 cm to 5 cm,
adding a deodorant liquid comprising 100 parts by weight of water and 20 parts to 40 parts by weight of an activated carbon powder 2 to 4 times as much the weight of the first ground product to obtain a second ground product,
heating the second ground product to a temperature in a range of 80° C. to 100° C. for 1 hour to 3 hours to obtain a gelatinized liquid,
cooling the gelatinized liquid to room temperature and then filtering the resulting liquid, and
controlling a viscosity using one or more types selected from glycerin, carrageenan, agar, and a modified starch.

9. A method of manufacturing an eco-friendly panel, the method comprising:
collecting a waste fiber, separating the collected waste fiber into a polyester-based fiber, a cotton fiber, and other fibers, and cutting the separated fiber into a predetermined size to manufacture a cotton-type fiber using a scutcher;
blending the cotton-type fiber to form a sheet-like felt using a molding machine and cross-linking the felt to form a mesh-type structure with a uniform density using a needle punching machine so that a plurality of waste fiber felt layers is formed;
desalting one or more types of seaweed wastes selected from brown, red, and green seaweed wastes with lukewarm water multiple times, grinding the desalted seaweed waste by adding 2 to 4 times as much water to obtain a mixture, and mixing the mixture with an activated carbon powder in an amount of 20% to 40% by weight of the mixture to obtain a mixed solution;
heating the mixed solution to a temperature in a range of 80° C. to 100° C. for 1 hour to 3 hours to obtain a gelatinized liquid, cooling the gelatinized liquid to room temperature, filtering the resulting liquid, and controlling a viscosity using one or more types selected from glycerin, carrageenan, agar, and a modified starch to prepare a viscous liquid;
mixing one or more types of powder selected from the group consisting of zeolite powder, bentonite, montmorillonite, orthoclase powder, elvan powder, jade powder, germanium powder, and baked shell powder with the viscous liquid in a weight ratio in a range of 1:1 to 2 to be applied on the plurality of waste fiber felt layers;
further applying a nano-carbon material in which flake graphite, graphene, and boron nitride are mixed thereon;
performing a first compression on the plurality of waste fiber felt layers on which the powder, the viscous liquid, and the nano-carbon material are laminated using a thermal compression molding machine at a temperature in a range of 150° C. to 220° C. at a pressure in a range of 100 kg/cm2 to 150 kg/cm2; and
performing a second compression using a cold press machine at a temperature in a range of 5° C. to 15° C. at a pressure in a range of 100 kg/cm2 to 200 kg/cm2, after the first compression.

10. The method of claim 9, further comprising applying 2 parts to 5 parts by weight of a non-slip agent, with respect to 100 parts by weight of the waste fiber felt layer, on the contact surface of each of the plurality of waste fiber felt layers on which the powder, the viscous liquid, and the nano-carbon material are laminated, before the first compression,
wherein the non-slip agent is a mixture in which one or more types of powder selected from the group consisting of a non-metal powder, a ceramic powder, aluminum oxide powder, and iron oxide powder are mixed, and the selected powder has a particle size of 200 mesh or less.
